(19) United States
(12) Patent Application Publication
(10) Pub. No.: US 2021/0060702 A1
(43) Pub. Date: Mar. 4, 2021

(54) LASER WELDED ALUMINUM BLANKS

(71) Applicant: Shiloh Industries, Inc., Valley City, OH (US)

(72) Inventors: Michael Telenko, Jr., Canton, MI (US); Jason E. Harfoot, Walled Lake, MI (US); Sam A. Kassoumeh, Canton, MI (US); Jack A. Atkinson, Brunswick, OH (US); James J. Evangelista, Northville, MI (US)

(21) Appl. No.: 16/644,060

(22) PCT Filed: Sep. 7, 2018
(86) PCT No.: PCT/US2018/050022

§ 371 Date: Mar. 3, 2020

Related U.S. Application Data
(60) Provisional application No. 62/555,339, filed on Sep. 7, 2017.

(51) Int. Cl. B23K 26/244; B23K 26/211

(52) U.S. Cl. CPC B23K 26/244; B23K 2103/10; B23K 26/211

(57) ABSTRACT

Welded parts and methods of manufacturing the same are disclosed. A welded part may include first and second metal workpieces having respective first and second edges forming a butt joint. The welded part may further include a first laser weld joining the first and second edges on one side of the first and second metal workpieces, and a second laser weld joining the first and second edges on another opposite side of the first and second metal workpieces. Some example parts may have laser welds that cooperate to extend across an entire depth of the butt joint and form an overlap zone between the first and second laser welds. In some examples, the first and second laser welds may be formed with substantially zero macroporosity.

### CROSS-REFERENCE TO RELATED APPLICATIONS

This application claims priority to U.S. Provisional Patent Application Ser. No. 62/555,339, filed on Sep. 7, 2017, the contents of which are hereby expressly incorporated by reference in their entirety.

### FIELD

The present disclosure relates to the welding of sheet metal blanks, and more particularly to the welding of sheet metal blanks made from an aluminum-based material.

### BACKGROUND

Metallic parts or workpieces may be joined using a laser welding process. Laser welds may be particularly convenient for joining relatively large sheet materials, e.g., as used in automotive or other vehicle applications, where other joining processes may not be convenient. This may be particularly so where weight reductions in a part are sought by reducing thicknesses in certain areas of the part, creating a need to join sheet materials of different thicknesses.

Metallic parts having welded components may be susceptible to failure in forming operations performed on the welded components. For example, where two sheetmetal blanks are welded together and subsequently stamped, it can be challenging to stamp desired features without creating cracks or other undesirable aspects in the weld or immediately adjacent sheetmetal. Such undesirable aspects can be particularly prevalent in sheetmetal blanks formed of aluminum materials, as the heat of a laser welding process may cause degradation in material properties of the sheetmetal blanks.

Accordingly, there is a need for an improved method of laser welding metallic parts.

### SUMMARY

According to one aspect, a welded part may include a first metal workpiece having a first edge and a second metal workpiece having a second edge, with the first edge positioned adjacent the second edge to form a butt joint between the first and second metal workpieces. At least one of the first or second metal workpieces may be formed of an aluminum-based material. The welded part may further include a first laser weld joining the first and second edges on one side of the first and second metal workpieces, with the first laser weld including material from both the first and second metal workpieces. The welded part may also include a second laser weld joining the first and second edges on another side of the first and second metal workpieces opposite the one side, with the second laser weld including material from both the first and second metal workpieces. The first and second laser welds may cooperate to extend across an entire depth of the butt joint and form an overlap zone between the first and second laser welds.

In another aspect, a welded part may include a first metal workpiece having a first edge and a second metal workpiece having a second edge, with the first edge positioned adjacent the second edge to form a butt joint between the first and second metal workpieces. At least one of the first or second metal workpieces may be formed of an aluminum-based material. The welded part may further include a first laser weld joining the first and second edges on one side of the first and second metal workpieces, with the first laser weld including material from both the first and second metal workpieces. The welded part may also include a second laser weld joining the first and second edges on another side of the first and second metal workpieces opposite the one side, with the second laser weld including material from both the first and second metal workpieces. The first and second laser welds may, in this example, be formed with substantially zero macroporosity.

According to another aspect, a method of manufacturing a welded part includes positioning a first edge of a first metal workpiece adjacent a second edge of a second metal workpiece to form a butt joint, with at least one of the first or second metal workpieces being formed of an aluminum-based material. The example method further includes laser welding the first and second edges from one side of the first and second metal workpieces to create a first laser weld, with the first laser weld including material from the first and second metal workpieces. The method may also include laser welding the first and second edges from another opposite side of the first and second metal workpieces to create a second laser weld, with the second laser weld including material from the first and second metal workpieces. The first and second laser welds may cooperate to extend across an entire depth of the butt joint and form an overlap zone between the first and second laser welds.

### DRAWINGS

FIG. 1A illustrates perspective views of various examples of welded parts for a vehicle body or structure, each of which may be produced using the exemplary methods described herein;

FIG. 1B illustrates perspective views of various examples of welded parts for a vehicle chassis, each of which may be produced using exemplary methods described herein;

FIG. 2A is a section view of two workpieces positioned for welding in a butt joint;

FIG. 2B is a section view taken through an exemplary weld joint between the two workpieces of FIG. 2A, illustrating a first weld of the workpieces;

FIG. 2C is a section view taken through the exemplary weld joint of FIG. 2A, illustrating a second weld of the workpieces;

FIG. 3 is a graph illustrating absorption by different metallic materials versus wavelength, where some of the wavelengths are for different types of laser welding;

FIGS. 4A-4F illustrate section and top views of weld samples demonstrating effects of laser power level used to propagate a second weld on the weld joint, in which:

FIG. 4A is a section view of a weld joint illustrating first and second welds formed in the joint using equal laser power levels;

FIG. 4B is a section view of a weld joint illustrating a second weld formed in the joint using a laser power level that is reduced compared to a laser power level used to form a first weld;

FIG. 4C is a section view of a weld joint illustrating a second weld formed in the joint using a laser power level that is even further reduced compared to a laser power level used to form a first weld; and

FIGS. 4D, 4E, and 4F are top views of the weld joints of FIGS. 4A, 4B, and 4C, respectively;

FIG. 5A is a perspective view of an illustration of a weld laser power distribution, according to an example approach;

FIG. 5B is a top view of the illustration of weld laser power distribution in FIG. 5A;

FIG. 6A is a perspective view of an illustration of an alternative approach to a weld laser power distribution;

FIG. 6B is a top view of the illustration of the alternative approach to weld laser power distribution in FIG. 6A;

FIGS. 7A-7G illustrate section views and top views of weld samples, and an associated hardness graph, demonstrating effects of filler wire used during an associated laser welding process on the weld joint, in which:

FIG. 7A is a section view of a weld joint illustrating a weld joint formed without filler wire;

FIG. 7B is a section view of a weld joint illustrating a weld joint formed using a first type of filler wire;

FIG. 7C is a section view of a weld joint illustrating a weld joint formed using a second type of filler wire; and

FIGS. 7D, 7E, and 7F are top views of the weld joints of FIGS. 7A, 7B, and 7C, respectively; and

FIG. 7G is a graph of material hardness along the weld joints illustrated in FIGS. 7A, 7B, and 7C;

FIGS. 8A-8F illustrate section and top views of weld samples demonstrating effects of shielding gas used during a welding process on the weld joint, in which:

FIG. 8A is a section view of a weld joint illustrating a weld joint formed without shielding gas;

FIG. 8B is a section view of a weld joint illustrating a weld joint formed with shielding gas at a first flow rate;

FIG. 8C is a section view of a weld joint illustrating a weld joint formed with shielding gas at a second flow rate that is higher than the flow rate illustrated in FIG. 8B; and

FIGS. 8D, 8E, and 8F are top views of the weld joints of FIGS. 8A, 8B, and 8C, respectively;

FIG. 9A is a perspective view of an exemplary weld fixture that may be used to weld two workpieces together, such as the workpieces illustrated in FIGS. 2A and 2B;

FIG. 9B is a schematic view of an exemplary laser welding process viewed in a direction perpendicular to a weld joint;

FIG. 9C is a schematic view of the exemplary laser welding process of FIG. 9B, viewed in a direction parallel to the weld joint; and

FIG. 10 is a process flow diagram for an example method of welding work pieces together.

### DESCRIPTION

The exemplary illustrations provided herein are directed to methods and systems for welding metallic workpieces together, such as tailor welded blanks where one or more of the sheet metal pieces is made of an aluminum-based material, as well as the welded parts that are results thereof. The term “aluminum-based material,” as used herein, broadly includes any material where the single largest constituent by weight is aluminum. This includes, for instance, pure aluminum and various aluminum alloys. Example methods disclosed may include steps for positioning first and second edges of respective workpieces adjacent each other to form a butt joint. The first and second edges may be welded together from a first side of the workpieces, e.g., using a laser welding process. After the workpieces cool sufficiently to allow the initial weld to at least partially re-solidify, the first and second edges may be welded from an opposite side of the workpieces. This two-stage welding process initially creates a first weld. The first weld penetrates into the butt joint from the first side to a first depth—the result of the first welding step. Whereas, in the second welding pass from the opposite side, a second weld is created as a result of the second welding pass. The second weld thus penetrates into the butt joint from the opposite second side to a second depth. The two welds generally overlap, such that the first and second depths cooperate to extend across an entire depth of the butt joint and form an overlap zone between the first and second welds. The creation of the second weld may thereby re-melt at least a part of the solidified first weld.

In some examples, a fixture may be employed for maintaining the workpieces in place during the welding process. For example, the workpieces may be secured to a fixture such that the adjacent edges of the workpieces are positioned for welding. In some examples, the fixture may generally apply a force to one or both workpieces, thereby urging opposing edges of the first and second workpieces together, during at least one of the laser welding steps.

The example welding methods disclosed herein may facilitate formation of generally flat aluminum welded blank assemblies, which can then be formed into a three-dimensional shape, e.g., in a subsequent stamping process. The two-stage welding process may generally increase overall part strength by reducing or eliminating reductions in material strength typical of previous welding approaches of aluminum materials, thereby minimizing the potential for part and/or weld joint failure. Previous welding approaches, such as those employing a single weld from only one side of the workpieces, generally have created insufficient strength in the weld joint, resulting in cracking or other failure of the joint or workpiece(s) adjacent the joint during subsequent forming processes such as stamping. Additionally, the flow of the molten material in the weld pool is generally difficult to control under previous welding approaches. Merely by way of example, molten material has been prone to flow out of the weld joint prior to solidification in these previous approaches.

In some examples, this increased strength results in elongation characteristics that are not decreased relative to initial material elongation properties. Thus, example welded parts may demonstrate an improved resistance to cracking, tearing, etc., during elongation of the weld. More specifically, while welded materials themselves may be capable of less elongation (and thus less resistant to failures such as tearing or cracks), samples welded using exemplary two-pass welding approaches described herein may be capable of relatively increased elongation compared with previous welding approaches.

The overlap of the welds and/or heat-affected zones has been found to influence the strength of the resulting weld joint, as will be described further below in connections with various examples. In some exemplary approaches, the first or top welding pass may have a first penetration depth of at least 60% of the thickest workpiece. The second or bottom welding pass may have a second penetration depth of at least 40% of the thickest workpiece. These ranges are generally a minimum value, and as will be seen below in the discussion of various examples, one or both penetration percentages will typically be higher than these minimum penetration depths in order to create desirable overlapping and weld joint strength.

Prior to the welding process, the edge regions of one or both workpieces may be prepared for welding, such as by laser ablation (e.g., to remove one or more coating and/or intermediate material layers such as an aluminum oxide coating), chemical, or mechanical methods, merely as examples. Edge regions may also be cleaned, e.g., to remove hydrated coatings. Such preparation may remove undesirable constituents from the weld region, improve alignment of the edges and/or reduce voids between the adjacent edges, thereby improving strength of the resulting weld.

Generally, workpieces may be fixtured or selectively secured for welding such that adjacent workpieces edges are flush, i.e., bottom surfaces of the workpieces are aligned. In one example, the bottom surfaces may be aligned even though there are insubstantial differences or tolerances, e.g., up to 0.003 inches between adjacent “flush” surfaces. The workpieces may have different thicknesses, different compositions, or in some alternative examples may be of the same thickness and/or composition.

As will be discussed further below, workpieces may be welded using a laser. Any suitable wavelength, spot size, spot shape, beam quality, and power may be used, although certain advantageous parameters will be discussed below with respect to specific examples. In some example illustrations, a laser may be selected based upon an absorption characteristic of the metal being welded. More specifically, where an aluminum-based material is used, a welding laser having a wavelength closely matching an absorption frequency of aluminum may be selected. Additionally, in some example approaches, a shield gas may be used on one or both of the first and second weld passes.

### Composite Welded Parts

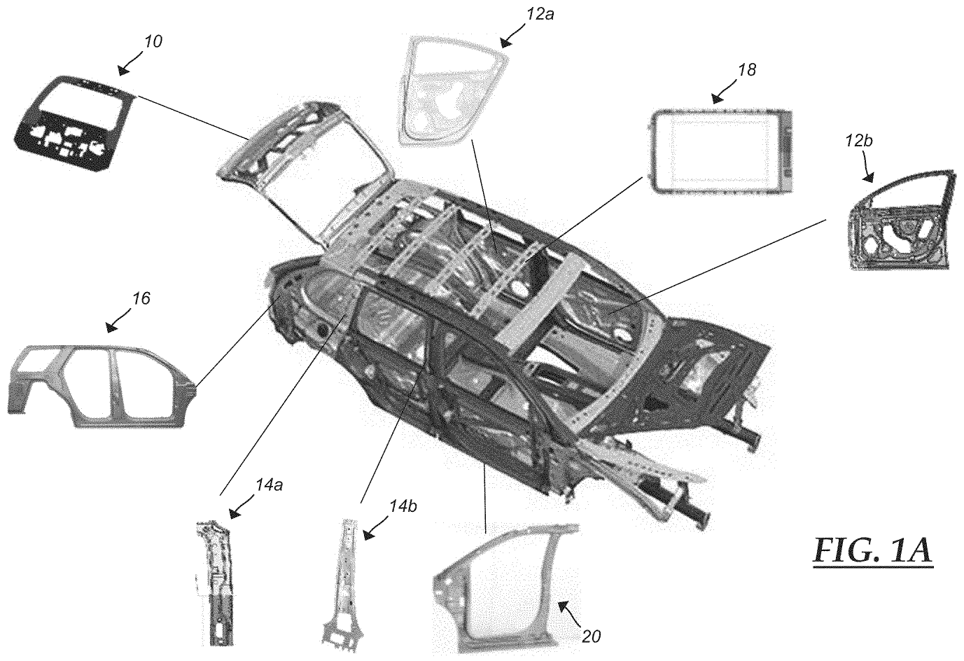

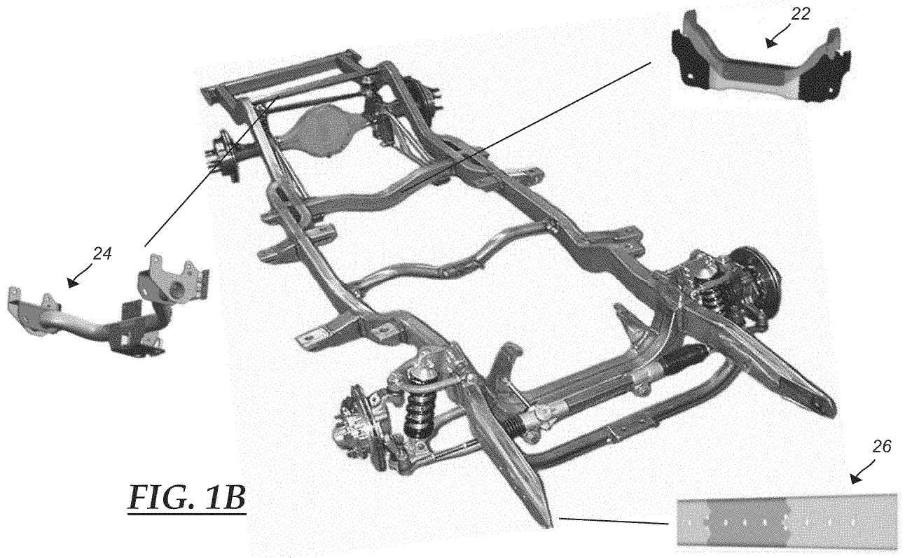

Turning now to FIGS. 1A and 1B, examples are provided of vehicle welded parts that may be created from workpieces that are welded by the present methods, including workpieces made of an aluminum-based material (i.e., pure aluminum and/or an aluminum-based alloy). Examples of such parts may include a “body-in-white” or other structural parts, e.g., as illustrated in FIG. 1A, such as closure panels (e.g., liftgate 10 or door panels 12a or 12b), pillar structures 14a or 14b, body side 16, roof/sunroof support structure 18, or door ring 20. In other examples illustrated in FIG. 1B, the vehicle welded parts include chassis parts such as cross member 22, trailer hitch component 24, or frame rail component 26 that may also be formed according to the exemplary welding methods taught herein.

Example methods may be applied to workpieces having different thicknesses, as will be described in further detail below. Such weld joints may be particularly well-suited for vehicle parts where a variation in the thickness of the sheet metal or blanks is desired, so as to provide focused or localized areas of strength (i.e., having thicker sheet metal in such areas) while minimizing the overall part weight by using thinner sheet metal in other areas. Such welded assemblies are oftentimes referred to as tailor-welded blank assemblies.

As mentioned above, workpieces that are joined using the exemplary two-pass welding methods described herein may have increased strength as compared with those formed in previous welding approaches (e.g., where a traditional single pass of a weld laser was employed). More specifically, material strength of the workpiece may be decreased by the weld to a lesser extent in comparison to previous welding approaches, or not at all. This increased strength may allow the workpieces to be formed into three-dimensional parts, such as in a subsequent stamping or drawing operation, while maintaining the integrity of the weld joint.

### Laser Welding Methods

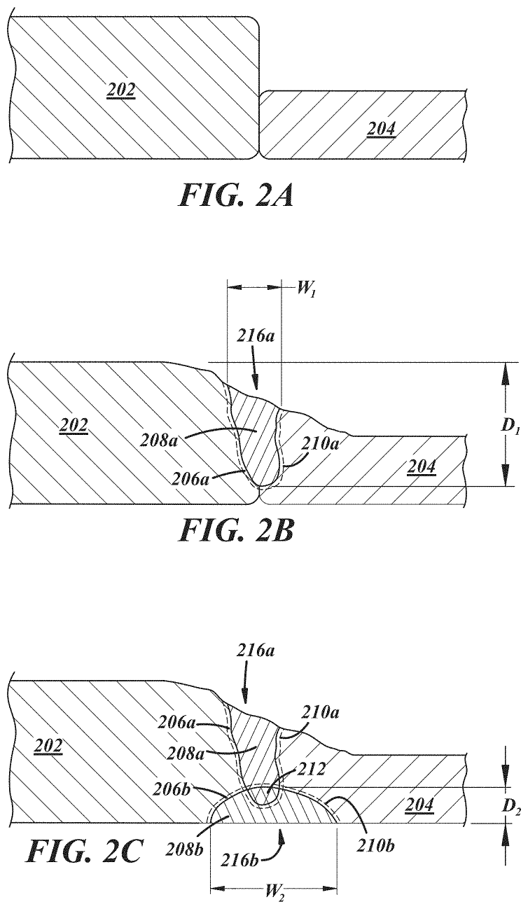

As noted above, overlap of the first and second welding passes may generally enhance strength of the resulting weld. Turning now to FIGS. 2A-2C, an example overlap zone for two workpieces positioned in a butt joint is illustrated. A first workpiece 202 may initially be positioned adjacent a relatively thinner second workpiece 204, as illustrated in FIG. 2A, and subsequently joined with the second workpiece 204, e.g., in a laser welding process to produce a tailor-welded blank assembly, as illustrated in FIGS. 2B and 2C.

While two work pieces 202, 204 are generally illustrated in the examples herein, these are merely examples and it will be understood that more than two work pieces may be joined in a variety of arrangements. For example, weld joints may be linear, multi-linear, or curvilinear. In another example, two or more work pieces may be joined along a single edge of a third work piece. Additionally, the work pieces 202, 204 may have a similar length along the joined edges thereof, or the work pieces being joined may have different lengths. The work pieces 202, 204 may also have any size and/or thickness that is convenient. The work pieces 202, 204 may have a same thickness, or define different thicknesses as illustrated in FIG. 2A. Additionally, the illustrated examples herein show the work pieces 202, 204 as having a sheet or planar configuration. Other configurations, e.g., non-flat, non-planar work pieces, may be employed instead. According to one example, at least one of the work pieces 202, 204 is a sheet made of an aluminum-based material and has a thickness of approximately 0.5 millimeters to 4.0 millimeters, inclusive. In another example, at least one of the workpieces is formed of an aluminum-based material and has a thickness of approximately 1.0 to 2.5 millimeters, inclusive.

In other example approaches, the work piece(s) 202, 204 may be formed of a steel material. Examples using steel materials may be advantageous where relatively thicker gauge material is employed, which may allow use of a relatively reduced laser power (compared with traditional one-pass laser welding approaches). In one example, work pieces 202, 204 formed of a steel material may have a thickness of approximately 0.5 millimeters to 5.0 millimeters, inclusive. In another example, work pieces 202, 204 formed of a steel material have a thickness of approximately 1.0 millimeters to 3.0 millimeters, inclusive.

Example methods described herein may be used to form weld joints between any number of different metallic materials, but are particularly beneficial for joining sheet metal workpieces or blanks made from an aluminum-based material, such as in a tailor welded arrangement. Suitable aluminum-based materials (i.e., either pure aluminum or aluminum-based alloys) may include, merely as examples, any aluminum alloy, e.g., 2xxx, 3xxx, 4xxx, 5xxx or 6xxx alloy material (an example of which is an aluminum 6061-T4 material). In some examples, the sheet metal workpieces or blanks may have various surface finishes, coatings, and/or pretreatments, e.g., a milled finish, an electric discharge texture (EDT) finish, or an oxide stabilization pre-coating, merely to cite a few possibilities.

After a first laser weld pass, the result of which is illustrated in FIG. 2B, a first laser weld 208a penetrates into the butt joint between the two workpieces 202, 204 by a depth D₁. In an example, the depth D₁ is at least 60% of the thickness of the thicker workpiece. The first laser weld region 216a includes the first weld zone 208a, as well as a first heat affected zone 206a and a first weld region boundary 210a, where the first weld zone 208a is at least partially surrounded by the first heat affected zone 206a, which in turn is at least partially surrounded by the first weld region boundary 210a. The term “heat affected zone,” as used herein, includes the area of the laser weld region where the workpiece base material has had its microstructure altered or affected by the heat energy of the welding process, but has not actually melted; whereas, the term “weld zone,” as used herein, includes the area of the laser weld region where the base material of one or both workpieces has actually melted and at least partially solidified. Thus, the first weld zone 208a may be visually delineated from the surrounding base material of workpieces 202, 204 and the heat-affected zone 206a by a noticeable transition or change in grain structure, grain size, grain orientation, etc.

Subsequently, the butt joint may be welded from an opposite side of the workpieces 202, 204, the result of which is illustrated in FIG. 2C. The second weld pass may penetrate the joint to a depth D₂. In an example, the depth D₂ is at least 40% of the thicker workpiece 202. The second weld pass creates a second laser weld region 216b which, like its first laser weld counterpart, includes a second weld zone 208b, a second heat affected zone 206b and a second weld region boundary 210b, where the second weld zone 208b is at least partially surrounded by the second heat affected zone 206b, which in turn is at least partially surrounded by the second weld region boundary 210b. The boundary or transition between a weld zone 208 and a heat affected zone 206 tends to be more subtle than a weld region boundary 210 between a heat affected zone 206 and the surrounding base material; but this is not always the case.

An overlap zone 212 is created at the overlapping intersection of the two laser weld regions 216a, 216b, and in particular with respect to the weld zones 208a, 208b. As will be described further below, the metal material in the overlap zone 212 is within the first and second weld region boundaries 210a, 210b and has been separately exposed to heat in each of the two weld passes of the two-pass welding methodology. Multiple thermal exposures from two weld passes or cycles, particularly if the workpieces 202, 204 are made of an aluminum-based material, may cause the microstructure of the overlap zone 212 to differ from that of the adjacent heat affected zones 206a, 206b, and/or the weld zones 208a, 208b that do not overlap another of the zones 206a, 206b, 208a, or 208b, each of which has only been exposed to a single thermal event.

In one example, sequential (as opposed to simultaneous) welding operations from the top and bottom sides of the weld joint may enable portions of the first and second laser welds 208a, 208b to melt and then solidify in a way that creates the overlap zone 212 and increases the strength of the weld. By allowing the first weld zone 208a and/or heat affected zone 206a to at least partially solidify before creation of the second weld zone 208b and/or second heat affected zone 206b, an overlap zone 212 having a microstructure with relatively smaller grain sizes may be created, resulting in increased strength of the weld joint. In this sense, the second weld pass may melt and/or thermally affect at least a portion of the first weld zone 208a and/or the first heat-affected zone 206a, thereby creating the overlap region 212 with a favorable grain structure as compared with a single pass of the weld laser.

While examples of minimum penetration depths are noted above, the overall strength of the resulting weld may be substantially affected by a degree of overlap between the two welds. Stated differently, the weld strength of the overall weld joint may be best achieved by a degree of overlap that is greater than a minimum penetration, but is less than a maximum penetration; this too is discussed below. In fact, in some examples discussed below, an excessive overlap of the first and second welds, or an excessive penetration of one of the first and second welds, may reduce the overall strength of the weld. In the non-limiting examples provided herein, the “depth” of a laser weld is the distance or extent to which a laser weld extends into a workpiece, as defined by its corresponding weld region boundary.

In one example, a first laser weld 208a has a depth D₁ or penetration into the joint of at least 80% of the thicker workpiece 202. The penetration is preferably less than 100% of the thickness of the thicker workpiece 202 (i.e., it does not burn all the way through) in order to prevent dripping or sagging of the molten base material. The second laser weld 208b penetrates to a depth D₂, which may be between 40% and 60% of the thicker workpiece 202. Thus, in this example, the first and second laser welds 208a, 208b overlap such that an overlap zone 212 has a thickness (i.e., in the same direction as the thickness of the workpieces 202, 204) of at least approximately 20% of the thicker material.

As noted above, weld joints having no overlap or insufficient overlap between first and second laser welds may result in reduced weld strength or failure of the weld during subsequent forming operations. For example, where the weld region boundaries 210a, 210b or welds 208a, 208b do not overlap at all, leaving a non-overlapped zone of base material in between, failure may occur due to insufficient strength from a lack of overlap. By contrast, improved welds using overlapping passes as described in the exemplary approaches herein typically allow the weld joints to demonstrate increased strength relative to previous welding approaches, and in some cases the base material may not significantly degrade in strength, e.g., as measured in standardized tests (e.g., Erichsen or Olsen cupping test, or the like). Additionally, in example overlapping weld approaches, failures in the welded part may tend to occur outside the weld joint in the base material, i.e., in the workpiece 202 or workpiece 204 in the example formed parts. This failure mode, i.e., in the base material outside the weld joint, is typically more desirable in such tests (which generally test the part until fail occurs, in order to determine where the failure occurs), at least in applications where subsequent formability of the welded piece (e.g., in a stamping operation) is important.

Excessive penetration of the laser welds may also have disadvantages. For example, where a second laser weld 208b penetrates through the entirety of the joint, and/or results in an overlap between the first laser weld 208a and second laser weld 208b of over 70%, the formed part may have reduced strength. For example, in one approach where the second weld 208b fully penetrated the joint (i.e., the depth D₂ was equivalent to the maximum thickness of the workpieces 202 and 204), and/or an overlap of over 70% between the depths D₁ and D₂ of the first and second welds 208a, 208b, the excessive penetration of the second laser weld 208b caused the sample to fail within the weld joint in subsequent formability testing.

As noted above, laser welding may be used in each of the first and second weld passes. Any suitable laser welding device or process may be used for each of the first and second passes. For example, a CO₂ laser, yttrium-aluminum-garnet (YAG) laser, a fiber laser, or diode laser such as a direct diode laser may be employed. While examples described below include certain laser welding equipment and parameters, such as the use of circular laser spots, other equipment and parameters may be used, e.g., a round, oval, or square laser spot.

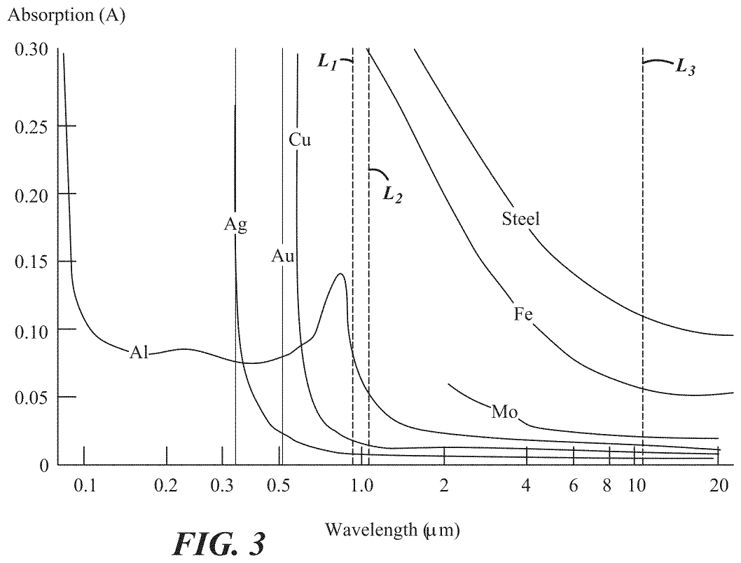

In some example approaches, a laser is selected based upon a wavelength of the laser being as close as possible to an absorption characteristic of the material being welded. Turning now to FIG. 3, material absorption curves are shown for different exemplary metals, where the wavelength of the laser corresponds to the x-axis and the amount of absorption corresponds to the y-axis. In one example, where workpieces 202, 204 are made from an aluminum-based material, a wavelength of a diode laser L₁ (which typically has an operating wavelength between approximately 900 and 1030 nm) may best match certain absorption characteristics of an aluminum-based material. More specifically, optimum aluminum absorption is at approximately 808 nm for a 100% aluminum material, and absorption of aluminum-based materials may be slightly different depending on alloying components or other conditions of the material. Thus, in one example an operating wavelength of the laser is selected between 800 nm and 900 nm. In another example, an operating wavelength of the laser is selected between 800 and 1000 nm. By contrast, the operating wavelengths of a fiber or neodymium-doped yttrium aluminum garnet (YAG) laser L₂ and a CO₂ laser L3 may be relatively higher. These other laser types L₂ and L₃ may thus be better matched to materials other than aluminum.

In some examples, a similar laser power, power density, spot size, etc., may be employed for each of the first and second passes with the weld laser. In other examples, differing welding parameters may be used in the first and second passes, such as using a reduced laser power and/or power density for the second weld pass when forming the second laser weld 216b.

In one example approach where an equal or reduced laser power is used for the second weld pass, the first laser weld 216a is created in the form of a keyhole weld. While different laser powers or different energy intensity welds may be employed where the workpieces 202, 204 have a same or similar thickness, in one example a higher power laser is used along the upper or stepped side of the workpieces 202, 204. As mentioned above, a keyhole weld may generally be characterized by elevated power levels and a relatively focused beam, which results in a relatively narrow laser weld formed at the joint. A subsequent weld pass from the opposite or lower side of the workpieces 202, 204 (e.g., the flush side) that creates the second laser weld 216b may exhibit a lower energy density than the first weld pass, and may form a conduction weld. As illustrated in FIGS. 2B and 2C, the second weld 208b may thus have a relatively wider width W₂ in comparison to the relatively narrow width W₁ of the weld 208a. The relatively lower-intensity weld or conduction weld of the second weld 208b is also visually distinguishable from the higher-intensity weld or keyhole weld of the first weld 208a by the shallower depth D₂ of penetration into the weld, compared with the depth D₁ of the first weld 208a.

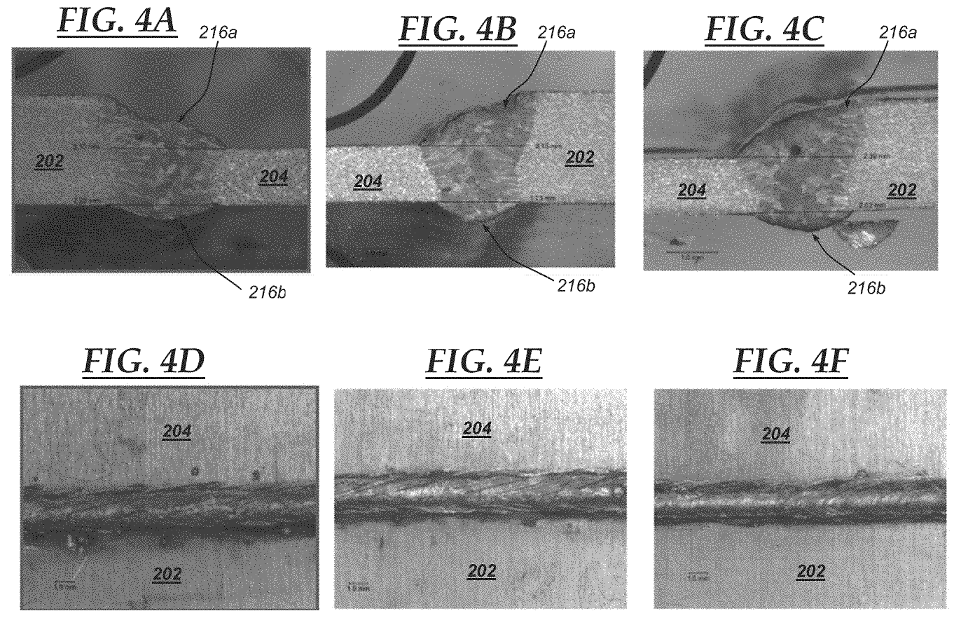

Turning now to FIGS. 4A-4F, examples of welds made where a laser power for the second weld pass is equal to or less than that of a first weld pass will be described in further detail. FIGS. 4A and 4D are sectional and bottom views, respectively, of the same sample; FIGS. 4B and 4E are sectional and bottom views, respectively, of the same sample; and FIGS. 4C and 4F are sectional and bottom views, respectively, of the same sample. Each of the samples shown in FIGS. 4A-4F were initially welded along a first side of the weld joint at a first power level of approximately 5.0 kW. Subsequently, each of the samples were welded along an opposite side of the weld joint. The sample shown in FIGS. 4A and 4D was welded at the same power level for the second pass, while the sample shown in FIGS. 4B and 4E was welded at a slightly reduced power level of 3.8 kW, and the sample shown in FIGS. 4C and 4F was welded at a more significantly reduced power level of 2.5 kW. The second laser welds 216b that were created using reduced power levels in the second/opposite side pass were formed with less weld spatter (compare, for example, FIGS. 4D and 4F), and resulted in a relatively smoother weld profile (compare, for example, FIGS. 4A and 4C).

A spot size, focus, power distribution and/or other laser welding parameter of a laser weld beam may also be altered for the first and second passes in an exemplary laser welding approach, e.g., in order to vary an energy intensity of the weld laser to create different types of laser welds in the workpieces 202, 204. In one example, the second/opposite side weld pass uses a laser spot size that is larger than the top pass, thereby reducing energy intensity. In one specific example, the spot size (e.g., diameter or radius of the laser spot created on the surface of the workpieces 202 and/or 204) is increased 100% as compared with the first weld pass. To execute such an increase in laser spot size, a laser beam may be defocused, for example.

In one example of defocusing a laser beam for the second/opposite side weld pass, a laser weld beam used in a first weld pass to create a first laser weld 216a is focused directly on the upper surfaces of the workpieces 202, 204. The focus upon the surface of the workpieces may have a “zero focus” with respect to the workpiece surfaces. In the subsequent laser weld on the opposite side, which creates the second laser weld 216b, the weld laser may be defocused such that a focal point corresponds to a position beyond the surfaces of the workpieces upon which the laser beam is trained. In one example, the laser in the subsequent weld pass on the opposite side of the workpieces is focused at a position that is between 1.0 mm and 10.0 mm beyond the workpiece surfaces, thereby expanding the laser spot size at the workpiece surfaces. In another example, the laser is defocused at a position that is 5.0 mm beyond the workpiece surfaces. In these examples, the weld laser that creates the first laser weld 216a at a stepped side of the workpieces may be the focused laser, whereas the weld laser that creates the second laser weld 216b at a flush side of the workpieces is the defocused laser. However, other embodiments are possible.

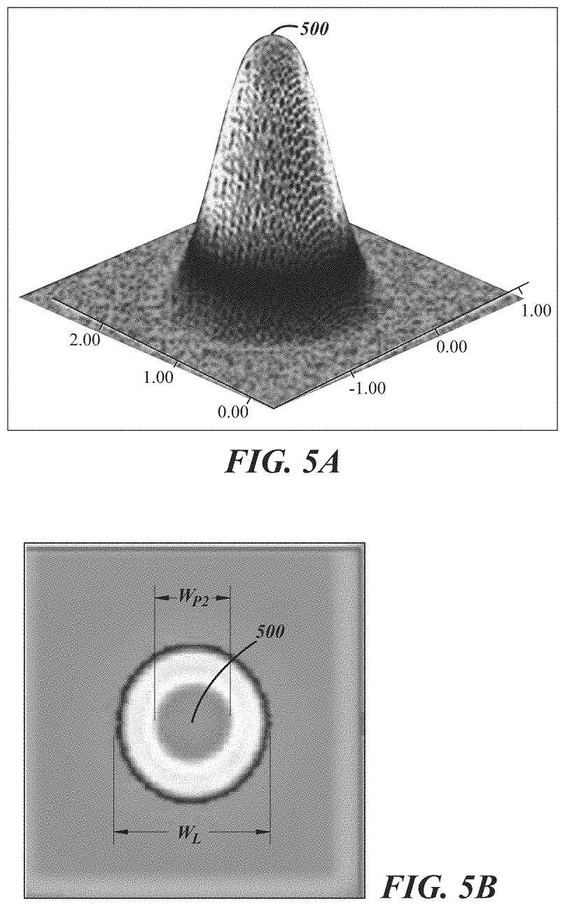

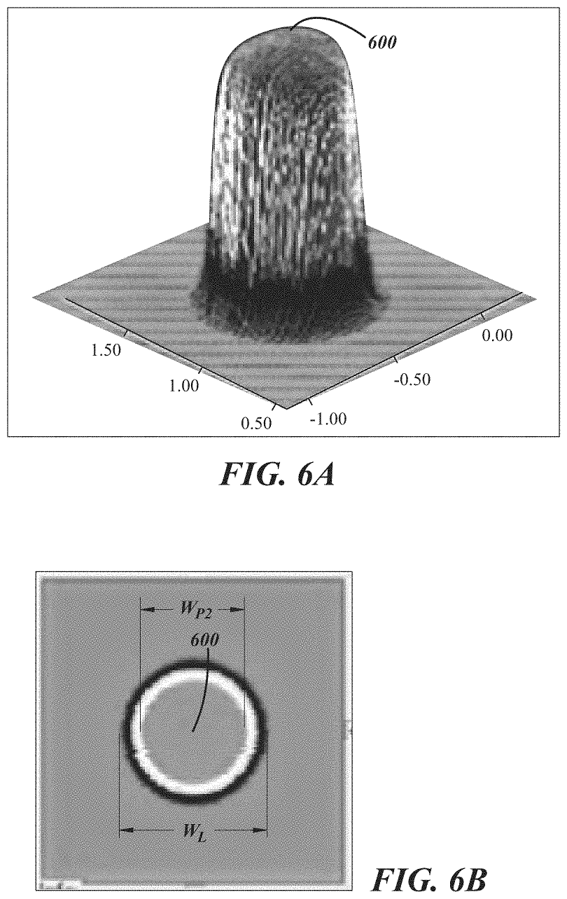

A change in laser spot size may also create a different power density distribution across the spot of the laser beam. For example, a power density of the laser may be focused more intensely toward a center of the laser beam, with power density decreasing more rapidly moving away from the beam center. Such an example is illustrated in FIGS. 5A and 5B, which show a Gaussian power density distribution. One measurement of the power distribution may be indicated by a percentage of the width W_{L} of the laser beam that the laser maintains a power density within a predetermined percentage of the peak power density. More specifically, as shown in FIG. 5B, a peak (or substantially so) power distribution is maintained across a width W_{P2} of the laser beam. By comparison, a more evenly distributed power density is illustrated in FIGS. 6A and 6B. In this illustration of a “top hat” power density distribution, peak power is maintained across a greater percentage of the overall beam width WL than in the Gaussian distribution shown in FIGS. 5A and 5B. In the example illustrated in FIGS. 6A and 6B, the peak power density is maintained across a width W_{P1} that is larger than the width W_{P2} of the Gaussian distribution. The more widely distributed power density illustrated in FIGS. 6A and 6B may be more effective for forming conduction-type welds, e.g., in the opposite side/second weld pass associated with the creation of the second laser weld 216b in the examples provided above.

While any suitable laser configuration and/or set of laser welding parameters may be employed, in one group of exemplary samples, the following parameters were proven to be particularly effective. A laser weld beam spot size of about 0.6 mm to 1.2 mm, a laser power of about 2,000 to 6,000 watts, and a laser wavelength of about 800 to 2,000 nanometers (nm). Moreover, as noted above, the wavelength of the laser may be selected based upon an absorption characteristic of the material being welded. A speed of the weld laser, i.e., the speed of the laser beam spot along the weld joint, may be about 2 to 10 meters/minute. In another example, a linear speed may be about 6 to 16 meters/minute. A weld laser may also employ a closed loop control, i.e., where some type of weld byproduct (e.g., the weld plume, reflected light from the weld, the size of the weld, etc.) is monitored so that the system can adjust or manipulate one or more weld parameters (e.g., weld power, focal point, etc.) during one or both passes of the laser. In one example of a closed loop control, penetration depth of the laser is monitored, and laser power is continuously adjusted to achieve desired penetration, e.g., at least 60% penetration in a first weld pass, and/or at least 40% penetration on second pass, as mentioned above. Additionally, while seam tracking may be provided to facilitate accurate tracking of the weld joint, in some examples seam tracking is not needed. More specifically, seam tracking may generally be helpful to ensure location of a laser weld beam. In some applications, e.g., where facing surfaces of the workpieces 202, 204 are flush or substantially so (e.g., along a back side of a multi-gauge weld joint, or where workpieces 202, 204 have a same gauge/thickness), seam tracking is relatively difficult. In such applications, other fixturing solutions can compensate for seam tracking and ensure appropriate location of the laser beam.

In addition to variations in laser power that may be made for the subsequent/opposite side laser weld compared with the first laser weld, an offset of the weld laser may be altered. In one example approach, the weld laser is offset by approximately 0.2 millimeters (mm) toward the thicker gauge material for the first weld pass to create the first laser weld 216a. In another example, the weld laser may be offset from 0.1 mm to 2.0 mm, inclusive. In these examples, the weld laser is not offset (i.e., the offset is zero and thus is aligned or otherwise focused directly on the seam between the edges of workpieces 202, 204) for the welding of the opposite side and creation of the second laser weld 216b.

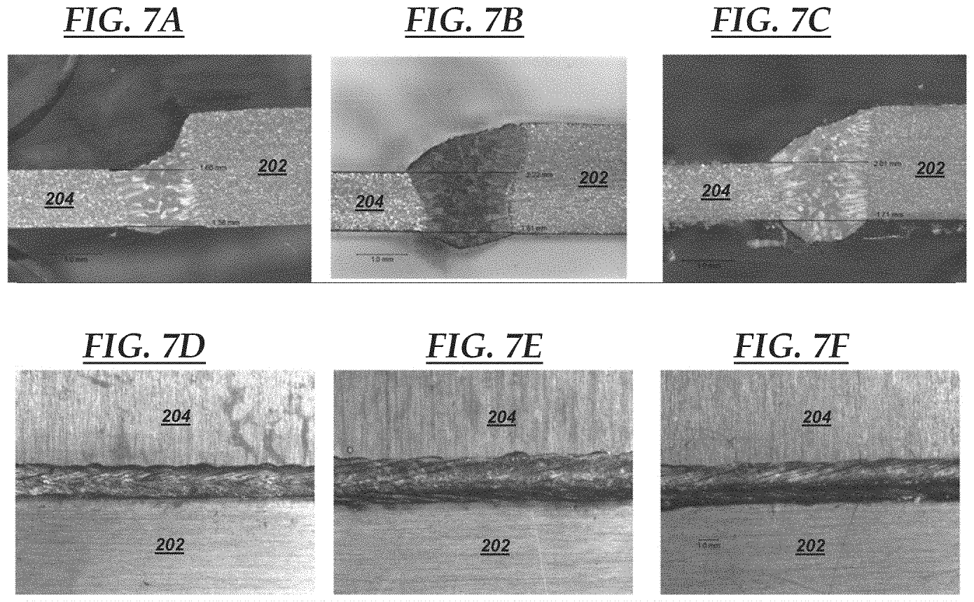

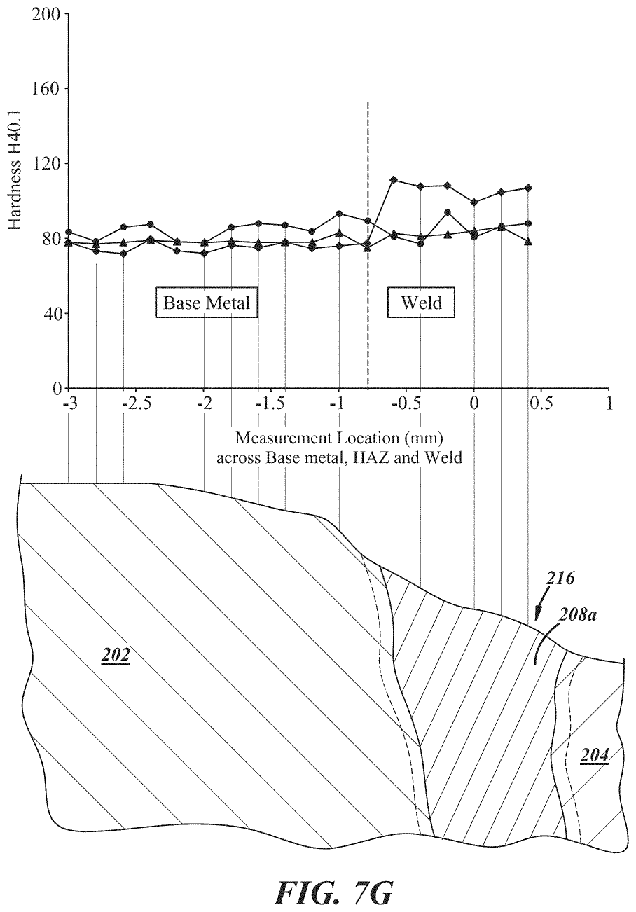

Example welding approaches may use filler material, e.g., filler wire, or alternatively weld joints may be formed between workpieces 202, 204 without any filler material. In some examples, filler wire of a different alloy than the base material is used, for example to compensate for chemical composition and behavior of the base aluminum 6xxx material during welding. In other cases, a same material/alloy may be employed for the filler wire as in a base metal, e.g., if filler wire is being used primarily or solely to increase the cross-section geometry in a same-gauge welding application. Turning now to FIGS. 7A-7G, examples of welded workpieces 202, 204 are illustrated that were formed without filler wire (see FIGS. 7A and 7D), with an aluminum 4xxx filler wire (in the example illustrated, a 4047 alloy filler wire; see FIGS. 7B and 7E), and with an aluminum 5xxx filler wire (in the example illustrated, a 5183 aluminum alloy filler wire; see FIGS. 7C and 7F). In these examples, a base material of an aluminum 6xxx material was employed, although the concepts relating to filler wire may be applicable to other materials. The examples using filler wire created weld joints having reduced concavity of the weld cross sectional shape. Moreover, the filler wire using the aluminum 4xxx material resulted in increased hardness, as illustrated in FIG. 7G. More specifically, FIG. 7G illustrates hardness measured along the surface of a welded part, i.e., at various positions in the base material approaching the weld region 216, and in the weld region 216. As illustrated, the base material may have a relatively uniform hardness that is not degraded, e.g., by tempering due to the proximity of the welds 208a, 208b. Accordingly, while the surface hardness may be relatively higher in the weld region 216, one or both of the workpieces 202, 204 may define a surface hardness adjacent the first weld 208a and/or the second weld 208b that is not degraded compared to a base material hardness of the first and second workpieces 202, 204. In some examples, such as that illustrated in FIG. 7G, the surface hardness along the workpieces 202 and/or 204 does not measurably decrease, e.g., as illustrated in the hardness measurements along the surface of the base material 202, extending into the heat-affected zone 206a, with the hardness substantially increasing in the weld zone 208a. While the improved hardness characteristics may not guarantee improved formability in all cases, the improved hardness characteristics may help prevent loss of hardness in the base material, e.g., due to a reduction in tempering of the base material resulting from the heat of the welding process(es).

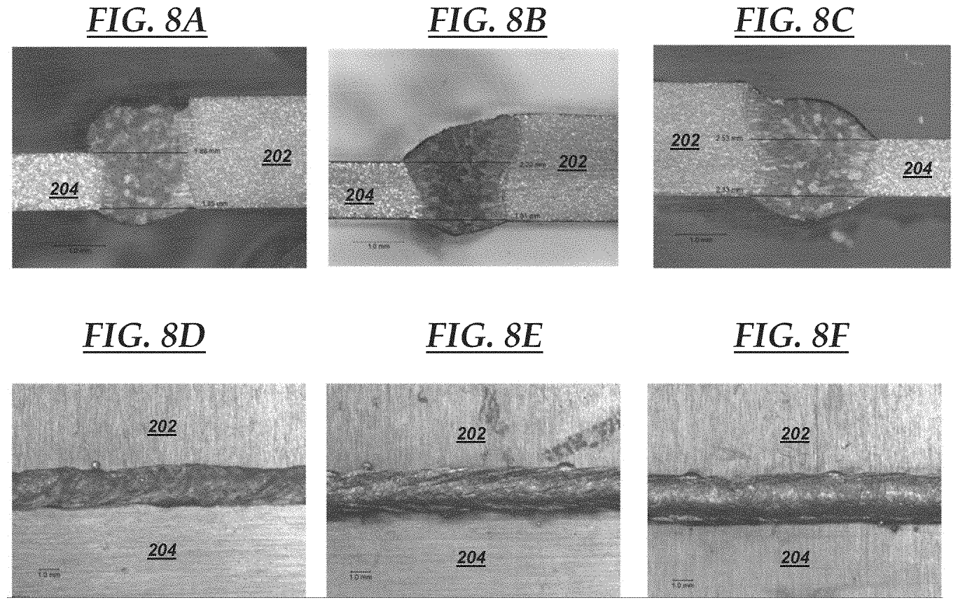

During welding of the joint between the workpieces 202, 204, shielding gas may be used during either or both weld passes. Shielding gas may improve cooling of the weld and reduce spatter. In addition to reducing porosity of the weld joint, use of shielding gas on either one or both welds has been found to promote a relatively smoother surface of the formed weld (compare, for example, FIG. 8A with FIGS. 8B and 8C) and reduce oxide formation on the weld surface. While any shielding gas may be used that is convenient, typically an inert gas is effective at reducing oxidation. In one example, a blend of Argon and Helium in substantially equal amounts was found to be effective. In another example, a 100% Argon gas flow was found to be effective. While gas flow rates were effective in the “medium” (10 L/min) and “high” flow rates (30 L/min) as reflected in FIGS. 8B and 8C, in another example a slightly higher flow rate, between 30 and 50 cubic feet per hour (CFH) (approximately 14.16 L/min to 23.60 L/min), was found to be effective.

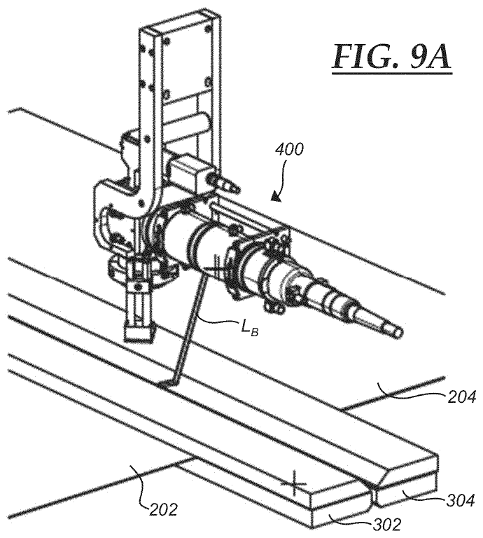

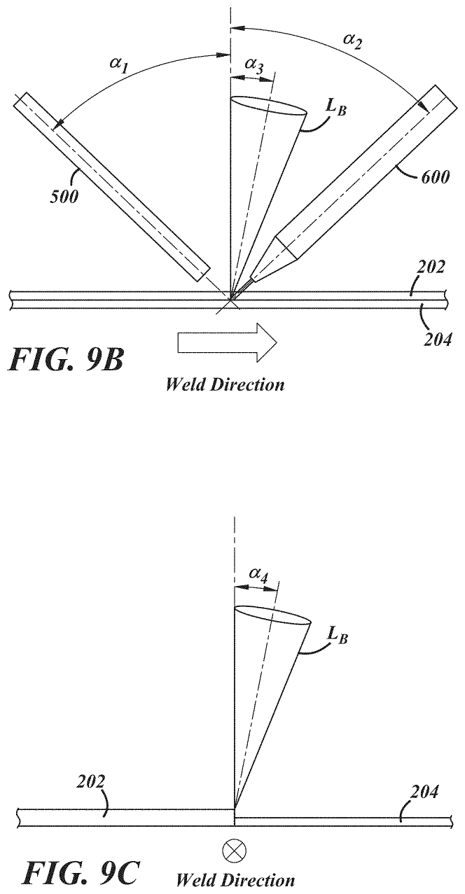

Turning now to FIGS. 9A-9C, an example weld fixture is illustrated that may be used to secure workpieces 202, 204 during a welding operation. Generally, the workpieces 202, 204 may be secured in place for a welding operation in any manner that is convenient. In some example approaches, the workpieces 202, 204 may be urged toward each other, such as by application of force pushing one or both of the workpieces toward the other, as one or both welds are being performed. In particular, a holding or clamping mechanism or fixture that reduces or prohibits rotational distortion and provides continuous horizontal force between the workpieces 202, 204 during at least the first weld pass helps achieve favorable grain structure and may also reduce porosity in the weld. The continuous horizontal force may be achieved by constraining one of the workpieces, while applying horizontal force to the other workpiece. In some cases, the force applied to the workpiece(s) may translate the workpiece(s), resulting in a portion of the workpiece(s) being consumed as the laser welding process melts material in the weld joint. Typically, it is desirable to minimize movement of the base material due to welding, however if slight movements of the base material occur due to melting of a seam or due to occurrence of pores in the weld, then a horizontally applied force can help minimize gap(s) and/or overcome any forces tending to open the weld seam or separate the workpiece edges.

In one example illustrated in FIG. 9A, a weld fixture includes first and second work piece supports 302, 304, as well as a laser head 400 configured to direct a laser weld beam L_{B} toward a weld joint between the workpieces 202, 204. As noted above, the joint between the two workpieces 202, 204 may first be welded from a first side of the joint to create a first laser weld (not shown in FIG. 9A). After the weld solidifies at least partially, the opposite side of the weld joint may be welded to create a second laser weld. In one example approach, the workpieces may be flipped or rotated to expose the second/opposite side of the joint to the laser head 400 and/or weld laser L_{B}. In another example approach, the laser head 400 and/or other pieces of the laser welder may be flipped or rotated to gain access to the second/opposite side of the joint. In still another example, a second laser head (not shown) positioned on a side of the weld joint opposite that of the laser head 400 may be used to form the second weld 208b.

The work piece supports each support a corresponding one of the first and second work pieces 202, 204. More specifically, the supports 302, 304 may position the first and second work pieces 202, 204 in contact with each other to facilitate welding the first and second work pieces 202, 204 together along edges thereof. In some exemplary approaches, the work pieces 202, 204 may be abutted together along facing edges, thereby facilitating the creation of a butt joint between the work pieces 202, 204. In this manner, a welded blank, e.g., a tailor welded blank, may be formed by the joining of the first and second work pieces 202, 204. Alternatively, other types of weld joints may be formed, including lap joints, combination butt and lap joints, joints between similar or dissimilar gauge material, joints between similar or dissimilar metals, etc.

The first work piece support 302 and second work piece support 304 may grip or secure their respective work pieces 202, 204 in any manner that is convenient. In one example, each of the work piece supports 302, 304 have one or more pads (not shown) for selectively grasping or gripping the associated work piece. Work pieces may be secured in place using clamps, magnets, or vacuum pads merely as examples. The use of a vacuum pad allows the work piece supports 302 and/or 304 to grip a work piece formed of virtually any type of material, including non-ferrous metals like aluminum. Accordingly, the fixture may be used to weld work pieces formed of any material susceptible to welding. Another advantageous aspect of the vacuum pads is generally reduced cycle times, which may result from the relative speed with which vacuum or reduced pressure is created, which in turns facilitates the vacuum pad gripping a work piece.

Referring now to FIGS. 9B and 9C, examples of a laser welding apparatus, e.g., for use in the fixture illustrated in FIG. 9A, are described in further detail. As noted above, a laser head 400 (not shown in FIGS. 9B and 9C) may be used to impinge a laser beam L_{B} upon workpieces 202, 204.

As shown in FIGS. 9B and 9C, the laser beam L_{B} may be angled with respect to the workpieces 202, 204 as it is moved along the joint between the workpieces. More specifically, as best seen in FIG. 9B, the laser beam L_{B} may define an angle α₃ vertically such that the laser beam L_{B} is angled downward relative to vertical in the plane of a “weld direction” (i.e., a direction of travel of the laser beam L_{B} and/or a seam between the workpieces 202, 204, referenced herein as an “x” direction) with respect to the workpieces 202, 204. Any inclination angle α₃ in the x direction may be used that is convenient, e.g., an angle of about 7.5°. In another example, an angle between about 0° and 10° may be employed. Alternatively or in addition to the inclination relative to weld direction, the laser beam L_{B} may define an angle α₄ vertically in a direction perpendicular to the “x” direction, as illustrated in FIG. 9C (i.e., in a “y” direction that is perpendicular to a direction of travel of the laser beam L_{B} and/or a seam between the workpieces 202, 204). Typically, where workpieces 202, 204 have different thicknesses as shown in FIG. 9C, the laser beam L_{B} may be angled toward the thicker workpiece 202. Merely as one example, the angle α₄ may be between 5° and 25°. In another example, angle α₄ is approximately 15.0°. As illustrated in FIG. 9B, example welding fixtures may have a shield gas nozzle 500 defining an angle α₁, and a filler wire feeder 600 defining an angle α₂. In one example, the angle α₁ is approximately 45°, and the angle α₂ is approximately 47.5°. Any other orientations or relative position of the shield gas nozzle 500 and filler wire feeder 600 may be employed that are convenient.

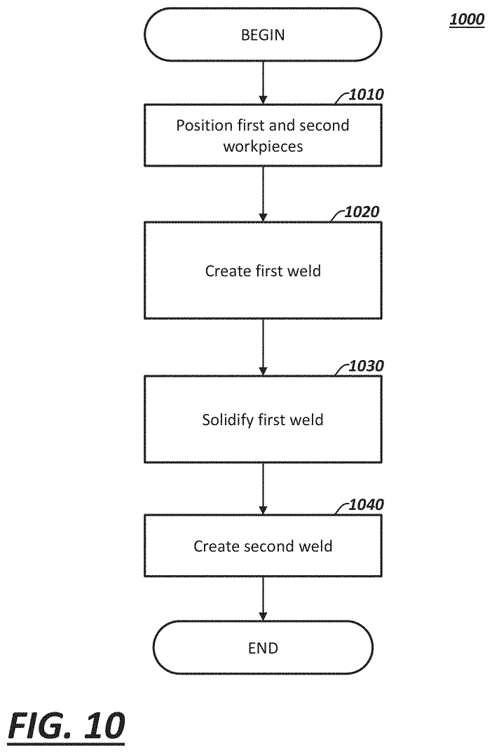

Turning now to FIG. 10, a process 1000 is illustrated for positioning and/or welding first and second work pieces together, where at least one of the work pieces is made from an aluminum-based material. Process 1000 may begin at block 1010, where first and second workpieces are positioned. More specifically, workpieces 202 and 204 may be secured adjacent each other such that respective facing edges are positioned for welding, as described above.

Moreover, in some example approaches, each of the workpieces 202, 204 may be secured to a weld fixture. In a tailor welded blank having work pieces with dissimilar thicknesses, the thicker piece is preferably positioned and secured first. Accordingly, first work piece 202 may be laid upon a first work piece support 302. The first work piece 202 may be positioned on the first work piece support 302 and aligned for being joined, e.g., via welding, to the second work piece 204 in any manner that is convenient. In one example, one or more gage pins are provided on the first work piece support 302 which engage an edge of the first work piece 202, e.g., one of the lateral edges not being welded to the second work piece 204, thereby aligning the lateral edge of the first work piece 202 with the gage pins. The gage pins may thereby align the first work piece 202 in an “x” direction, i.e., parallel to the weld edge. The second workpiece 204 may be subsequently laid adjacent the first workpiece 202, and may be secured to a work piece support 304.

Proceeding to block 1020, a first laser weld may be created in the first and second work pieces, e.g., via a laser welding process. The creation of the first laser weld may occur subsequent to the securing of the first and second workpieces 202, 204. For example, as described above a laser head 400 may be used to form a first laser weld 216a and join the first and second work pieces 202, 204 together from a first stepped side. Portions of the first and second workpieces 202, 204 may be melted, with the first laser weld 216a penetrating into the butt joint from the first side to a first depth, as described above. During the welding process, a gas may be circulated in an exhaust gas chamber adjacent the weld site, e.g., to provide shielding, cooling, and/or exhaust with respect to gases created as a result of the welding of the first and second workpieces 202, 204. It is also possible that the exhaust gas chamber could utilize reduced pressure created by an external vacuum source to help remove the exhaust gases. Process 1000 may then proceed to block 1030.

At block 1030, at least a portion of the first laser weld 216a (e.g., the first heat-affected zone 206a) may be allowed to re-solidify, e.g., after the welded or melted material has fallen below a certain temperature.

At block 1040, the first and second edges may be welded from an opposite side of the workpieces. Moreover, the welding from the opposite side of the workpieces 202, 204 may occur after the re-solidification of at least a portion of the first weld in block 1030, such that at least some material is melted or welded, allowed to re-solidify, and then melted or welded again at block 1040. Accordingly, a second laser weld 216b may be created that penetrates into the butt joint between workpieces 202, 204 from the opposite side to a second depth.

As noted above, various parameters of the laser welding processes, e.g., as described in blocks 1020 and 1040, may be optimized in order to increase weld strength. In one example, one or more of the following parameters may be maintained during a welding process:

laser power is maintained between 2.0 and 6.0 kilowatts (kW);

a linear speed of the laser along the workpieces is maintained between 6.0 and 16.0 meters/minute;

a shield gas comprising a generally 100% Argon, blend (e.g., 50/50) of argon (Ar) and helium (He), or other gas convenient for laser welding is provided adjacent the joint at a flow rate of 30-50 cubic feet per hour (CFH);

a laser head tilting angle of approximately 4.0 to 6.0 degrees (and in one example, approximately 5.0 degrees), such that the laser beam has the same angle relative to vertical, assuming horizontally oriented workpieces);

a laser beam focal height of approximately zero (i.e., the laser beam is vertically focused upon upper surface(s) of the workpieces 202 and/or 204) is employed during a first or top pass of the weld;

a defocused laser beam (i.e., the laser beam is vertically focused upon a vertical position above the surface(s) of the workpieces 202 and/or 204) is employed during a second or bottom pass of the weld;

a laser beam is offset approximately 0.1 to 0.3 millimeters (and in one example approach, approximately 0.2 millimeters) toward the thicker gauge material;

each of the workpieces 202, 204 are fixtured in place during the welding processes; and

the workpieces 202, 204 are urged together or otherwise have a force applied between the two workpieces 202, 204 during at least the first laser welding step.

Moreover, in some example approaches, all of the above parameters may be employed.

In some examples, the first and second workpieces 202, 204 may be urged together during the formation of either or both of the first and second laser welds 216a, 216b. More specifically, as described above the workpieces 202, 204 may be secured in a weld fixture. A constant force may be applied to one or both workpieces 202, 204, such that the facing edges of workpieces 202, 204 are maintained in alignment.

Additionally, as described above, the first and second depths of the first and second laser welds 216a, 216b may cooperate to extend across an entire depth of the butt joint. The laser welds 216a, 216b may thereby form an overlap zone 212 between the first and second laser welds, as defined by the two overlapping weld region boundaries 210a, 210b. The creation of the second laser weld 216b may re-melt at least a part of the solidified first laser weld 216a.

In one example welding process found to be particularly effective, a weld laser with an operating wavelength coupled with an absorption of aluminum material, e.g., a direct diode laser, is employed to form overlapping first and second laser welds, while a force is applied between the workpieces 202, 204 during the formation of the first laser weld. In another particularly effective example, the laser power or energy intensity of a laser forming the first laser weld is relatively higher than that of a laser forming the second laser weld, e.g., resulting in the first laser weld being formed as a relatively narrower and/or deeper “keyhole” type laser weld in comparison to the comparatively wider and/or shallower conduction-type weld.

Process 1000 may then terminate or continue with other known post-welding steps.

The example welding approaches described herein employing two sequential laser weld passes along opposing sides of a weld joint to create an overlap zone facilitate creation of a welded part having improved strength, at least as compared with previous laser welding approaches. In previous welding approaches, particularly with respect to workpieces formed of aluminum-based materials, were prone to significant material strength degradation in the workpieces adjacent the welds. The increased strength of welded parts under the examples disclosed herein, by contrast, may allow the welded part to be formed, e.g., in a stamping, rolling, or other manufacturing process, subsequent to the welding processes. As noted above, example welding approaches may improve performance of welded joints in standardized tests such as in stress/strain tests (e.g., by improving elongation performance compared with previous welding approaches, or improving performance in other standardized tests, e.g., Ericksen or Olsen cup testing) compared with previous welding approaches.

Example welding approaches may also provide reduced porosity in the weld joint. More specifically, previous laser welding approaches typically created bubbles in the welded material sufficient to reduce strength in the resulting weld by forming voids or spaces in the joint which may be visible, e.g., in x-ray imaging of the joint. By comparison, example welding approaches, e.g., as described above at blocks 1020 and 1030, may create substantially zero macroporosity. As used herein, the term “substantially zero macroporosity” means there are no visible large pores or voids in x-ray imaging of the weld joint (e.g., no pores or voids that are larger than 30% of the thickness of the thinner of the workpieces). In fact, example welding approaches such as those described above in blocks 1020 and 1030 may also create little, if any, microporosity, or voids/pores smaller than those visible in x-ray imaging at average magnification power.

It is to be understood that the foregoing description is not a definition of the invention, but is a description of one or more exemplary illustrations of the invention. The invention is not limited to the particular example(s) disclosed herein, but rather is defined solely by the claims below. Furthermore, the statements contained in the foregoing description relate to particular exemplary illustrations and are not to be construed as limitations on the scope of the invention or on the definition of terms used in the claims, except where a term or phrase is expressly defined above. Various other examples and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A welded part, comprising:
a first metal workpiece having a first edge; and
a second metal workpiece having a second edge, the first edge is positioned adjacent the second edge to form a butt joint between the first and second metal workpieces, wherein at least one of the first or second metal workpieces is formed of an aluminum-based material;
a first laser weld joining the first and second edges on one side of the first and second metal workpieces, the first laser weld includes material from both the first and second metal workpieces; and
a second laser weld joining the first and second edges on another side of the first and second metal workpieces opposite the one side, the second laser weld includes material from both the first and second metal workpieces;
wherein the first and second laser welds cooperate to extend across an entire depth of the butt joint and form an overlap zone between the first and second laser welds.

2. The welded part of claim 1, wherein the first and second laser welds are formed with substantially zero macroporosity so that no voids larger than 30% of a thickness of the thinner of the first and second workpieces are present in the first and second laser welds.

3. The welded part of claim 1, wherein the first laser weld is formed from a higher energy density laser than the second laser weld so that the first laser weld has a first weld depth (D₁), and the second laser weld has a second weld depth (D₂) that is less than the first weld depth, and the first laser weld has a first weld width (W₁), and the second laser weld has a second weld width (W₂), wherein the first weld width is less than the second weld width.

4. The welded part of claim 1, wherein the first laser weld is a laser keyhole weld, and the second weld is a laser conduction weld.

5. The welded part of claim 1, wherein the first laser weld penetrates into the weld joint to a weld depth (D₁) that is at least 60% of a maximum thickness of the first and second workpieces, and the second laser weld penetrates into the weld joint to a weld depth (D₂) that is at least 40% of the maximum thickness of the first and second workpieces.

6. The welded part of claim 1, wherein the overlap region comprises between 20-40% of a maximum thickness of the first and second workpieces.

7. The welded part of claim 1, wherein the first and second workpieces have different first and second gauges, respectively, and wherein the first laser weld is formed on a stepped side of the workpieces, and the second laser weld is formed on a flush side of the workpieces.

8. The welded part of claim 7, wherein at least one of the first and second laser welds includes a filler wire material.

9. The welded part of claim 8, wherein at least one of the first and second workpieces defines a surface hardness adjacent the first and second laser welds and a relatively higher weld hardness along a welded surface, the surface hardness being substantially similar to a base material hardness of the at least one of the first and second workpieces.

10. The welded part of claim 7, wherein the first laser weld is offset towards a thicker one of the first and second workpieces, and the second laser weld is aligned with the butt joint between the first and second workpieces.

11. The welded part of claim 1, wherein each of the first and second workpieces is formed of an aluminum-based material that has a thickness between 0.5 millimeters (mm) and 5.0 mm, inclusive.

12. The welded part of claim 1, wherein the welded part is one of a welded blank assembly and a formed welded part.

13. A welded part, comprising:
a first metal workpiece having a first edge; and
a second metal workpiece having a second edge, the first edge is positioned adjacent the second edge to form a butt joint between the first and second metal workpieces, wherein at least one of the first or second metal workpieces is formed of an aluminum-based material;
a first laser weld joining the first and second edges on one side of the first and second metal workpieces, the first laser weld includes material from both the first and second metal workpieces; and
a second laser weld joining the first and second edges on another side of the first and second metal workpieces opposite the one side, the second laser weld includes material from both the first and second metal workpieces;
wherein the first and second laser welds are formed with substantially zero macroporosity such that no voids larger than 30% of a thickness of the thinner of the first and second workpieces are present in the first and second laser welds.

14. A method of manufacturing a welded part, comprising:
positioning a first edge of a first metal workpiece adjacent a second edge of a second metal workpiece to form a butt joint, wherein at least one of the first or second metal workpieces is formed of an aluminum-based material;
laser welding the first and second edges from one side of the first and second metal workpieces to create a first laser weld, the first laser weld includes material from the first and second metal workpieces; and
laser welding the first and second edges from another opposite side of the first and second metal workpieces to create a second laser weld, the second laser weld includes material from the first and second metal workpieces; and
wherein the first and second laser welds cooperate to extend across an entire depth of the butt joint and form an overlap zone between the first and second laser welds.

15. The method of claim 14, further comprising re-solidifying at least a portion of the first laser weld prior to forming the second laser weld.

16. The method of claim 14, further comprising urging the first and second workpieces together during at least one of the laser welding steps

17. The method of claim 16, wherein urging the first and second workpieces together forms the first and second laser welds with substantially zero macroporosity such that zero voids larger than 30% of a thickness of the thinner of the first and second workpieces are present in the first and second laser welds.

18. The method of claim 14, wherein the first laser weld is formed with a first laser energy density, and the second laser weld is formed with a second laser energy density, wherein the first laser energy density is higher than the second laser energy density.

19. The method of claim 14, wherein the first laser weld is formed to define a first weld depth (D₁) and a first weld width (W₁), and wherein the second laser weld is formed to define a second weld depth (D₂) less than the first weld depth, and the second laser weld is formed to define a second weld width (W₂) larger than the first weld width.

20. The method of claim 14, wherein the laser welding includes using a laser having an operating wavelength of 800-1000 nanometers (nm), inclusive.

21. The method of claim 20, wherein the laser is a direct diode laser.

22. The method of claim 14, wherein the first laser weld is formed to penetrate to a weld depth (D₁) that is at least 60% of a maximum thickness of the first and second workpieces, and the second laser weld is formed to penetrate to a weld depth (D₂) that is at least 40% of the maximum thickness of the first and second workpieces.

23. The method of claim 14, wherein the overlap zone comprises 20-40% of a maximum thickness of the first and second workpieces.
